(19) United States
(12) Patent Application Publication
(10) Pub. No.: US 2016/0172808 A1
(43) Pub. Date: Jun. 16, 2016

(54) COMBINED AUDIO/VIDEO AND ALTERNATING CURRENT (AC) POWER MODULE

(71) Applicant: Leviton Manufacturing Co., Inc., Melville, NY (US)

(72) Inventors: William J. Lauby, Mukilteo, WA (US); Dean S. Lipke, Mill Creek, WA (US); Frank Kim, Woodinville, WA (US)

(21) Appl. No.: 14/572,721

(22) Filed: Dec. 16, 2014

(51) Int. Cl. H01R 27/02; H01R 13/66; H04N 5/44; H01R 24/64

(52) U.S. Cl. CPC H01R 27/02; H01R 24/64; H01R 13/6691; H04N 5/44

(57) ABSTRACT

A wall-mounted combination module combines AC power and audio-video (A/V) signaling in a single-gang wall box. The combination module comprises an AC power receptacle and an A/V data port, providing both AC power and a data connection for display devices or A/V content source devices. A/V signaling is passed between the A/V data port on the front face of the module and another data port on the rear side of the module, which can be communicatively connected to another wall-mounted module at another location using a copper cable, a fiber optic cable, or a wireless link. The module may also include signal extending electronics for signal amplification, conditioning, correction, or conversion. DC power for the active A/V signaling components are provided by a power converter within the wall box that converts AC power from the AC receptacle to DC power.

### TECHNICAL FIELD

The disclosed subject matter relates generally to audio-video connectivity, and, for example, to a compact combination wall-mounted module that combines alternating current (AC) power with audio-video signaling.

### BACKGROUND

Until relatively recently, televisions were designed only to receive and display content via over-the-air broadcasts. In parallel with the advent of cable television, optical disk players, streaming video set-top boxes, and on-line audio-video content, modern televisions have evolved to support reception and display of content from a variety of data sources. To accommodate these disparate data sources, today's televisions may include several different types of audio/video (A/V) input ports, including but not limited to high-definition multimedia interface (HDMI), universal serial bus (USB), RJ45, or other such ports.

In some scenarios, an A/V source device—e.g., digital video disk (DVD) or high-definition disk players, streaming video boxes, etc.—may be located near the television, allowing that device to be plugged directly into the appropriate input port of the television. In other configurations, the A/V source device may be located in a different room relative to the television, requiring the A/V cable connecting the television to the source device to be routed through the wall. In these latter configurations, the A/V cable from the source device may be terminated on the rear side of a wall plate on which is mounted an A/V output port for connection to the television. To ensure that alternating current (AC) power does not cross over onto the A/V signal lines (a potential safety hazard), users are often required to install two separate wall boxes—one housing an electrical outlet to provide power to the television, and a second housing the A/V signal output port.

Moreover, the finite power and signal integrity capabilities of the A/V signal cable often limit the allowable distance between the television and the A/V signal source. As the distance between the television and the signal source increases in excess of these signal integrity capabilities, signal levels may be attenuated as a function of cable resistance and the signal becomes increasingly susceptible to interference and signal timing errors.

The above-described deficiencies of current A/V configuration architectures are merely intended to provide an overview of some of the problems of current technology, and are not intended to be exhaustive. Other problems with the state of the art, and corresponding benefits of some of the various non-limiting embodiments described herein, may become further apparent upon review of the following detailed description.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments relate to a combination module that combines AC power and A/V signaling in a compact modular form factor. In one or more embodiments, a combination module can comprise a single-gang wall box and a front-mounted faceplate. An AC power receptacle can be installed in a first section of the wall box (e.g., the top or bottom section), with the AC outlet facing outward through the faceplate. An A/V port can be installed in a second section of the wall box, above or below the AC outlet. The A/V port can conform to any appropriate A/V port type, including but not limited to HDMI, USB, DisplayPort, RJ-45, or other port types. The combination module can be mounted near an A/V source or display device, thereby providing both AC power and signal connectivity for the device. The combination module passes A/V signals between the front-facing A/V port on the faceplate and a rear-facing A/V port that connects to an A/V signal cable within the wall (e.g., an HDMI cable, a category cable, etc.). The A/V signal cable can be routed from the rear of the combination module to another wall-mounted module located near a mating device, allowing signals to be sent from a content source device to a display device in another location.

In some embodiments, the A/V port may be a pass-through port that passively conveys A/V signals between the front-facing A/V port and the rear-facing A/V port. In other embodiments, the A/V port may be part of an active A/V signal transceiver module that includes active electronics for signal extension, amplification, correction, and/or conversion. In such embodiments, the combination can also include an AC-to-DC power converter that converts alternating current (AC) power from the AC receptacle to direct current (DC) power suitable for powering the transceiver electronics. This configuration eliminates the need for separate power adaptors and associated AC outlets.

In some embodiments, the A/V signal transceiver can include protocol transformation functionality that converts the A/V signal between a native format corresponding to the A/V port type on the front face of the module and a non-copper format (e.g., fiber optic or wireless) corresponding to the rear-facing signal port. By converting the A/V signal to a non-copper (non-conductive) format within the combination module, the risk of electrical crossover between the AC wiring and the signal wiring within the wall box is reduced or eliminated.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the drawings. It will also be appreciated that the detailed description may include additional or alternative embodiments beyond those described in this summary.

### BRIEF DESCRIPTION OF DRAWINGS

FIG. 1 is a diagram illustrating a configuration in which data signals and power are provided to a television or display via separate wall boxes.

FIG. 2 is diagram of a single wall box solution for providing AC power and A/V signaling.

FIG. 3A is a diagram illustrating a front view of an example combination module comprising an AC power receptacle and a pass-through A/V signal module.

FIG. 3B is a diagram illustrating a side view of an example combination module comprising an AC power receptacle and a pass-through A/V signal module.

FIG. 3C is a diagram illustrating a rear view of an example combination module comprising an AC power receptacle and a pass-through A/V signal module.

FIG. 4 is a diagram illustrating AC power and data connections between a combination module and a television.

FIG. 5 is a diagram illustrating a link between a content source and a television using a combination module.

FIG. 6A is a diagram illustrating a front view of an example combination module that includes an A/V signal receiver module.

FIG. 6B is a diagram illustrating a side view of an example combination module that includes an A/V signal receiver module.

FIG. 6C is a diagram illustrating a rear view of an example combination module that includes an A/V signal receiver module.

FIG. 7 is a diagram illustrating a link between a content source and a television using a combination module that includes an A/V signal receiver module.

FIG. 8 is a diagram illustrating a link between a content source and a television in which a pass-through combination module is installed on the source end.

FIG. 9A is a set of three-dimensional drawings illustrating a modular combination module.

FIG. 9B is a three-dimensional front view of an assembled modular combination module.

FIG. 9C is a three-dimensional rear view of an assembled modular combination module.

FIG. 10 is a diagram of a side view of a modular outlet system including a divider plate between the AC and A/V signal sides.

FIG. 11 is a three-dimensional view of a removable divider module.

FIG. 12A is a diagram of a front view of an example combination module that includes fiber optic conversion capabilities.

FIG. 12B is a diagram of a rear view of an example combination module that includes fiber optic conversion capabilities.

FIG. 12C is a diagram of a side view of an example combination module that includes fiber optic conversion capabilities.

FIG. 13 is a diagram illustrating an example wiring configuration that uses a fiber optic combination module on both the source end and the display end.

FIG. 14 is a diagram illustrating connections between a fiber optic combination module with AC power capabilities and a combination module without native AC power.

FIG. 15 is a diagram illustrating an example wiring configuration between a content source and a television using active and passive fiber optic combination modules.

FIG. 16A is a diagram of a front view of a combination module that leverages wireless technology to connect the source and display ends of an A/V link.

FIG. 16B is a diagram of a side view of a combination module that leverages wireless technology to connect the source and display ends of an A/V link.

FIG. 17 is a diagram illustrating an example configuration that uses a combination module with a wireless transceiver component on both the source end and the display end.

FIG. 18A is a diagram of a front view of a combination module in which an AC outlet, a USB charging port, and an A/V port are combined in a single-gang.

FIG. 18B is a diagram of a side view of a combination module in which an AC outlet, a USB charging port, and an A/V port are combined in a single-gang.

FIG. 19A is a diagram illustrating a front view of an example combination module that combines an AC power outlet, an Ethernet port, and a USB charging port within one single-gang wall box.

FIG. 19B is a diagram illustrating a rear view of an example combination module that combines an AC power outlet, an Ethernet port, and a USB charging port within one single-gang wall box.

FIG. 20 is a flowchart of an example methodology for provisioning both AC power and A/V signaling within a single integrated outlet box.

FIG. 21 is a flowchart of an example methodology for configuring an outlet box with both AC power and an A/V port with active signal extension electronics.

FIG. 22 is a flowchart of an example methodology for sharing AC power and A/V signaling within a single-gang outlet box while mitigating risk of cross-over between AC and signaling lines.

FIG. 23 is an example computing environment.

FIG. 24 is an example networking environment.

### DETAILED DESCRIPTION

The subject disclosure is now described with reference to the drawings wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As used in the subject specification and drawings, the terms “object,” “module,” “interface,” “component,” “system,” “platform,” “engine,” “selector,” “manager,” “unit,” “store,” “network,” “generator” and the like are intended to refer to a computer-related entity or an entity related to, or that is part of, an operational machine or apparatus with a specific functionality; such entities can be either hardware, a combination of hardware and firmware, firmware, a combination of hardware and software, software, or software in execution. In addition, entities identified through the foregoing terms are herein generically referred to as “functional elements.” As an example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer-readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As an example, a component can be an apparatus with specific functionality provided by mechanical parts operated by electric or electronic circuitry, which is operated by software, or firmware application executed by a processor, wherein the processor can be internal or external to the apparatus and executes at least a part of the software or firmware application. As another example, a component can be an apparatus that provides specific functionality through electronic components without mechanical parts, the electronic components can include a processor therein to execute software or firmware that confers at least in part the functionality of the electronic components. Interface(s) can include input/output (I/O) components as well as associated processor(s), application(s), or API (Application Program Interface) component(s). While examples presented hereinabove are directed to a component, the exemplified features or aspects also apply to object, module, interface, system, platform, engine, selector, manager, unit, store, network, and the like.

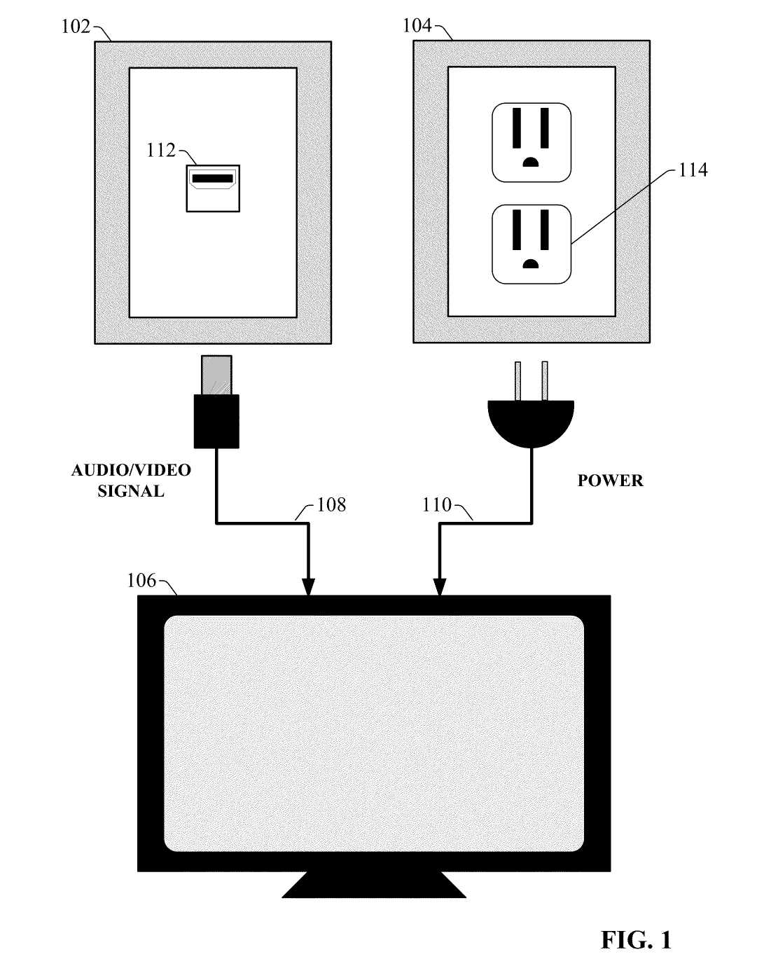

FIG. 1 is a diagram illustrating a configuration in which data signals and power are provided via separate wall boxes. In this example, an HDMI port 112 is mounted on wall plate 102, which may be mounted near television 106. The HDMI input port (not shown) on television 106 is connected to the HDMI port using a standard HDMI cable 108, while the television's power cable 110 is plugged into a separate electrical outlet 114 mounted on wall plate 104. This configuration maintains separation between AC power and low-voltage A/V signaling by using two separate wall boxes for power and A/V signals. However, the use of two wall boxes enlarges the wall space requirements and requires additional installation labor.

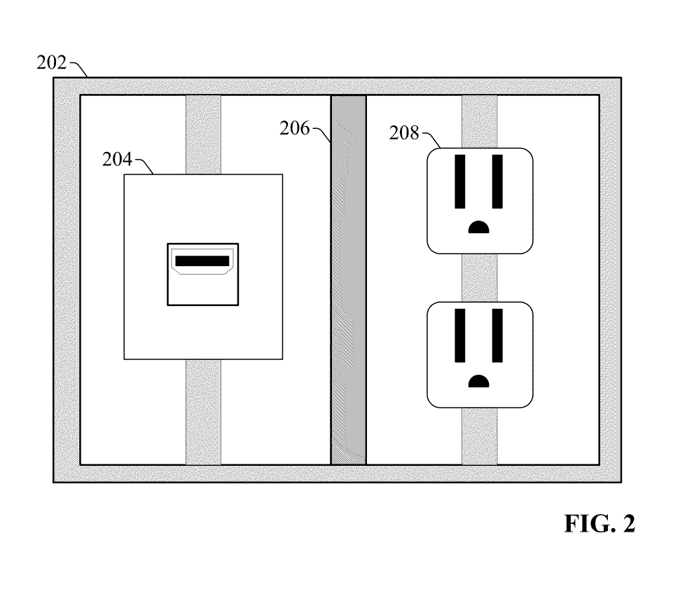

FIG. 2 is diagram of an alternative single wall box solution for providing AC power and A/V signaling. In this example, rather than installing the HDMI output port and AC outlet in separate wall boxes, a single double-gang wall box 202 houses both the HDMI port 204 and the AC outlets 208 in separate gangs. A divider plate 206 resides between the high-voltage and low-voltage sides to prevent cross-over between the AC lines and the A/V signal lines. While possibly reducing the wall space requirements relative to the separate wall plate solution illustrated in FIG. 1, the double-gang wall box 202 nevertheless requires a wide wall footprint to accommodate the double-gang box and is typically more expensive than a single-gang box.

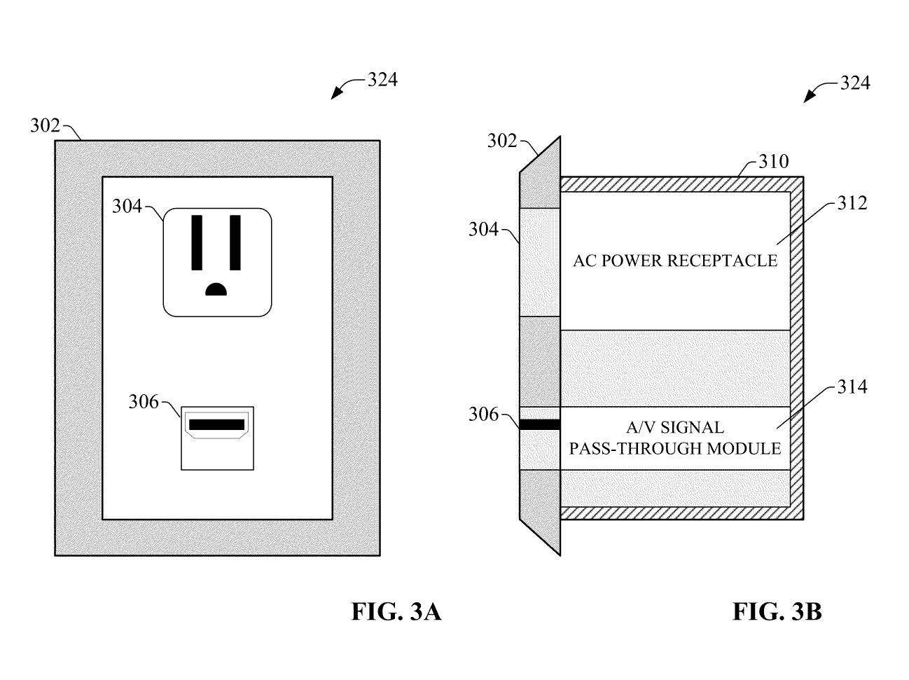

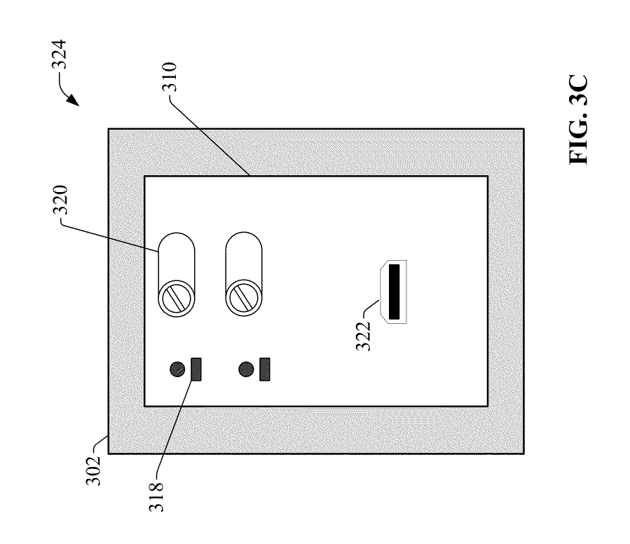

In order to simplify the hardware and installation requirements and to reduce wall space requirements, one or more embodiments of the present disclosure provide a wall-mounted assembly that combines the AC power receptacle with the A/V port in a single integrated module that can be installed in a standard single gang wall box. FIGS. 3A-3C are diagrams illustrating front, side, and rear views, respectively, of an example combination module 324. The combination module 324 comprises a module housing 310 with a faceplate 302 mounted on a front side of the housing. In this example, AC power receptacle 312 resides in a top portion of module housing 310, such that the associated power outlet 304 is located on a top portion of faceplate 302. An A/V signal pass-through module 314 resides in the lower portion of module housing 310. In this example, the A/V signal pass-through module 314 comprises an HDMI port 306, which is located on the lower portion of faceplate 302. Although FIGS. 3A-3C depict A/V signal pass-through module 314 as an HDMI module, other types of A/V signal pass-through modules are also within the scope of one or more embodiments described herein, including but not limited to video graphics array (VGA), USB, digital video interface (DVI), DisplayPort, coaxial, binding post, banana jack, RJ-45, RJ11, Radio Corporation of America (RCA), Bahyonet Neill-Concelman (BNC), Thunderbolt, or other types of A/V signal ports.

AC power terminals are provided on the rear side of the module to allow the AC receptacle to be connected to building main AC power (e.g., via a breaker). These AC power terminals can comprise any suitable type, including but not limited to push-in terminals 318 and/or screw terminals 320 or modular connector such as Leviton Lev-Lok®. An A/V port 322—in this case, an HDMI port—is also provided on the rear side, allowing the HDMI cable from the data source to be plugged into the module.

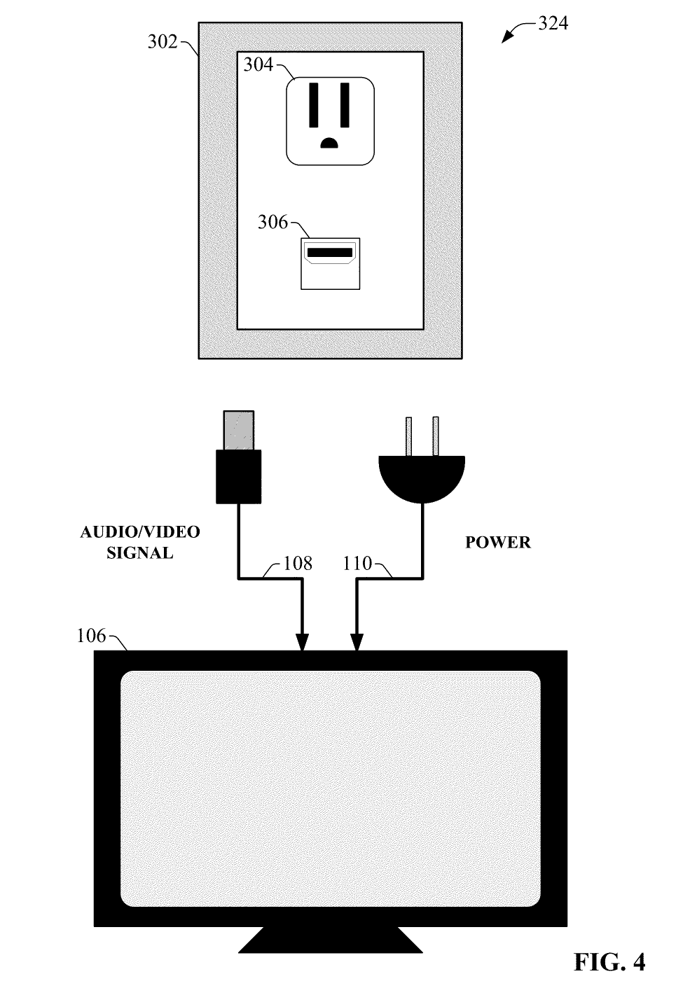

The module housing 310 and faceplate 302 fully enclose the AC power receptacle 312 and A/V signal pass-through module 314 inside the combination module 324, and the combination module 324 can be installed in a single gang wall box and mounted to a wall. As shown in FIG. 4, the combination module 324 allows both the television's AC power cable 110 and HDMI cable 108 (or other type of A/V signal cable) to reside inside one single-gang wall box without the need for a divider inside the wall box, since AC power receptacle 312 and A/V signal pass-through module 314 are fully enclosed and mutually isolated within the module. This single-gang solution reduces the required wall space footprint and installed cost relative to the solutions depicted in FIGS. 1 and 2 and allows the faceplate to be more easily hidden behind the television. The design depicted in FIGS. 3A-3C eliminates the need for separate single gang wall boxes or multiple gang wall boxes with a divider between the AC and signal gangs.

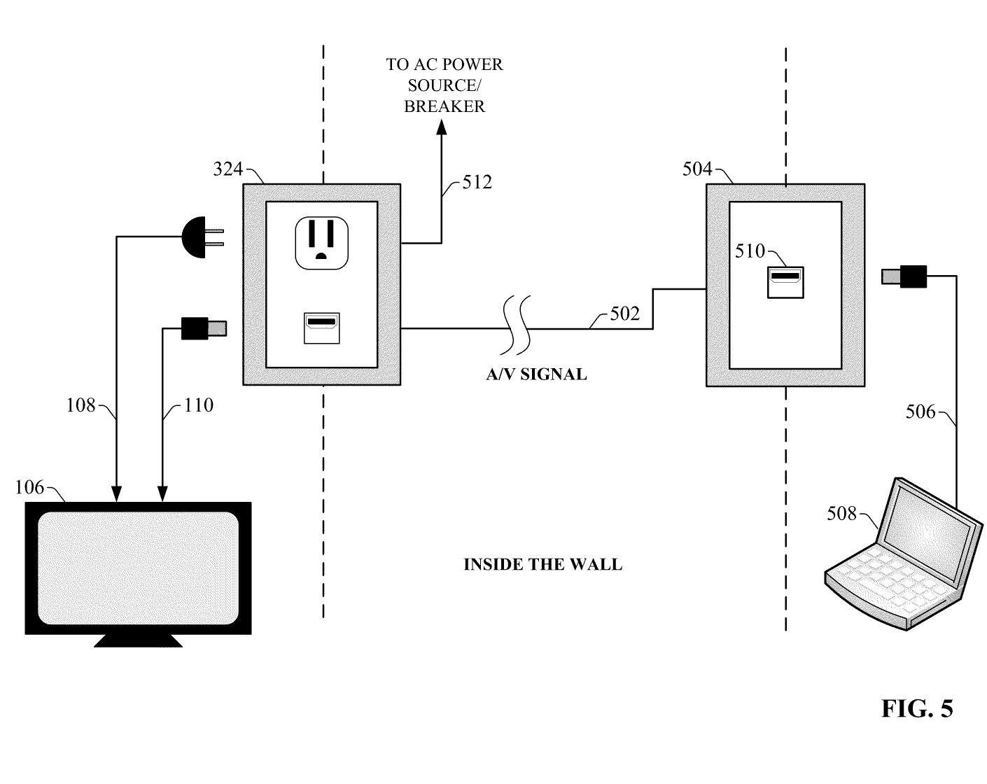

FIG. 5 is a diagram illustrating a link between a content source 508 (e.g., a computer, a DVD player, a digital video recorder, a set top box, a game console, a personal device, etc.) and a television 106 using the combination module 324 described above. The television's power cable 110 and HDMI cable 108 are connected to the AC power receptacle and HDMI port, respectively, of combination module 324. Inside the wall, the AC power receptacle of the combination module 324 is connected to an AC power source (e.g., via a breaker) using AC cable 512, which connects to the rear side of the combination module 324 using either the push-in terminals 318 or screw terminals 320 of the AC power receptacle 312 (see FIG. 3C). A/V signal cable 502 is plugged into the A/V port 322 on the rear side of combination module 324 and runs through the wall to a mating A/V signal pass-through module 504 at another location. The mating A/V signal pass-through module 504 is housed in a single-gang wall box mounted to the wall near the content source 508, allowing the content source to be plugged into an HDMI port 510 on the front of the box.

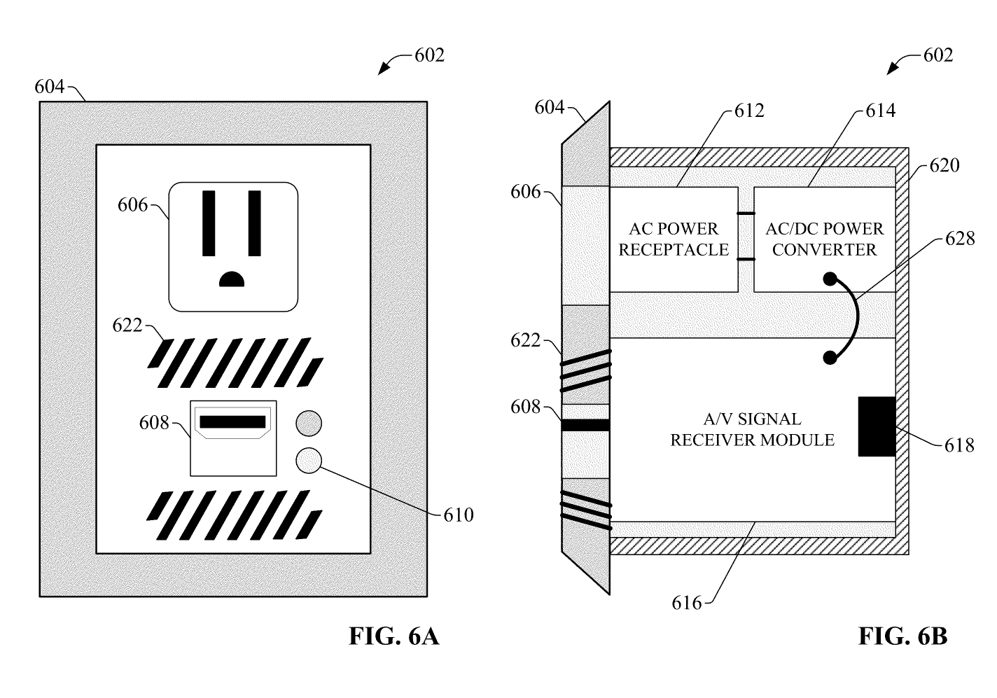

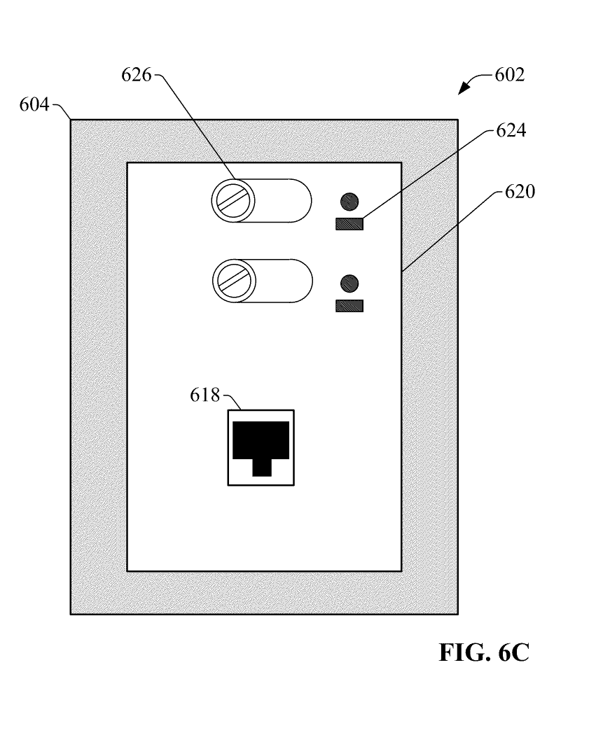

The example combination module illustrated in FIGS. 3-5 is suitable for configurations in which the distance between the content source 508 and the television 106 is within the operating range set forth by the A/V signal specifications (i.e., no signal regeneration/extender electronics are necessary to ensure that a sufficiently strong signal reaches television 106). To accommodate longer distances between the source and receiving ends, some embodiments of the combination module may also include integrated signal regeneration components. FIGS. 6A-6C are diagrams illustrating front, rear, and side views, respectively, of an example combination module 602 that includes an A/V signal receiver module 616. Similar to the combination module 324, combination module 602 includes an AC power receptacle 612 housed within a top section of a module housing 620. The AC power receptacle 612 connects to building main AC power via push-in connectors 624 or screw connectors 626 located on the back side of the module, and provides AC power to an outlet 606 that faces through faceplate 604. An A/V signal port 608 faces through the lower portion of faceplate 604. Although depicted as an HDMI port in FIGS. 6A and 6B, A/V signal port 608 may comprise substantially any type of A/V signal port (e.g., VGA, USB, DVI, DisplayPort, Thunderbolt, RJ-45, RJ11, etc.).

A/V signal receiver module 616 is housed in the lower section of the module housing 620, and comprises A/V signal extender circuitry (e.g., an HDMI, HDBaseT, or DisplayPort extender chipset, or other signal conditioning and amplification electronics) configured to amplify weakened signals received via the A/V signal input port 618 on the rear side of the combination module 602. In this example, A/V signal input port 618 is an RJ-45 port for receiving HDBaseT signals over category cable (e.g., CAT-5, CAT-6, etc.). In some embodiments, the A/V signal receiver module 616 can also correct signal timing to comply with HDMI signal specifications.

To provide power to the A/V signal receiver module 616, an AC-to-DC power converter 614 is housed in the upper portion of the module housing 620 and is electrically connected to AC power receptacle 612. When the AC power receptacle 612 is connected to main AC power, power converter 614 converts AC power from the receptacle to DC power—e.g., 120 AC volts (VAC) to 3.3 DC volts (VDC)—which is fed to A/V signal receiver module 616 via an internal connection 628.

The AC power receptacle 612, AC-to-DC power converter 614, and A/V signal receiver module 616 are fully enclosed by the module housing 620 and faceplate 604 (with the exception of the outlets/ports exposed on the front and rear sides of the combination module 602). In some embodiments, faceplate 604 may include ventilation slots 622 to promote airflow and heat dissipation, mitigating the risk of overheating of the signal extender chipset of the A/V signal receiver module 616. The A/V signal receiver module 616 may also include other heat dissipation features, including but not limited to heat sinks or thermal sensing and control in order to maintain a proper operating temperature and to limit temperatures to levels that comply with appropriate building and safety codes.

Though depicted as a receiver in FIGS. 6A-6B, the A/V signal module may comprise either a receive-only module (for use near a display device), a transmit-only module (for use near a source device), or a transceiver component that can be used at either the source or display end of the link. A/V signal receiver module 616 may also include one or more indicators 610 (e.g., light-emitting diodes (LEDs), audible signal generators, electronic text display, etc.) that convey health or communication status for the HDMI port 306 (e.g., data source connected and ready, A/V signal module power OK, data received, etc.).

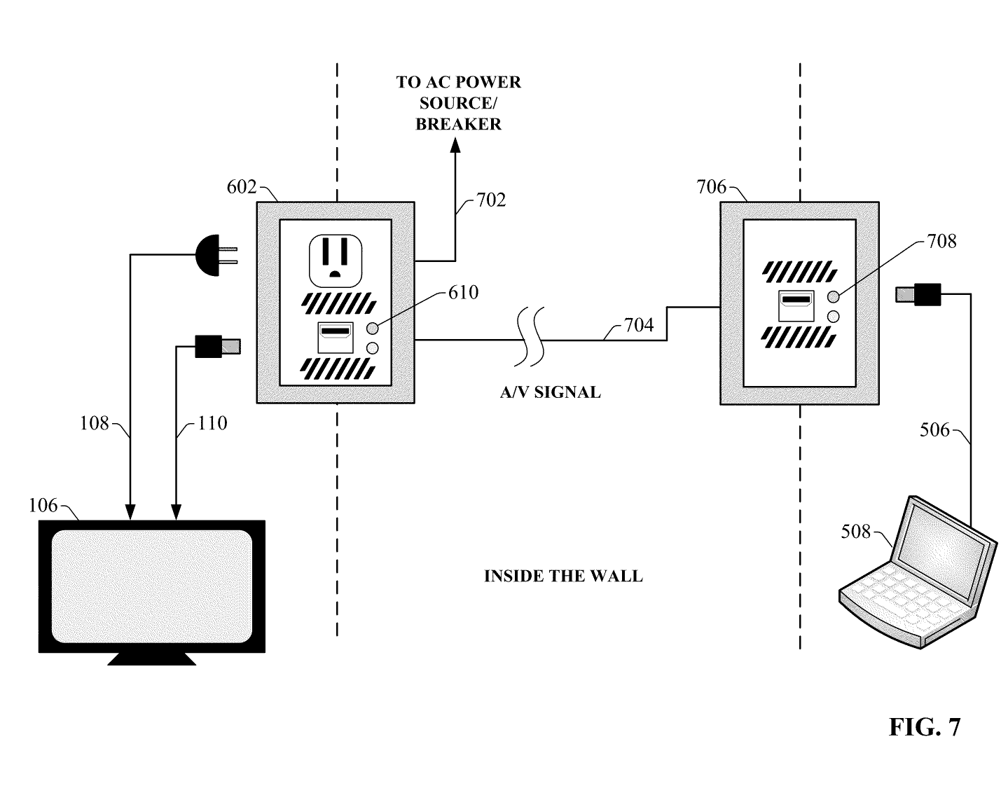

The configuration illustrated in FIGS. 6A-6C yields a compact, fully enclosed, self-contained module that provides both AC power and HDBaseT-to-HDMI signal receiving and conditioning. The combination module 602 can be installed in a single-gang wall box for mounting, thereby providing both AC power and A/V signaling in a single gang. FIG. 7 is a diagram illustrating a link between content source 508 (e.g., a computer, a DVD player, a digital video recorder, a set top box, a game console, a personal device, etc.) and television 106 using combination module 602 described above. The connections shown in this example configuration are similar to those described above in connection with FIG. 5. In this example, a category cable 704 (e.g., CAT-5, CAT-6, etc.) routed through the wall provides an HDBaseT link between combination module 602 and a mating HDMI input module 706 mounted on a wall near the content source 508. The category cable 704 plugs into an RJ-45 port on the rear side of the mating HDMI input module 706 (similar to RJ-45 port on the rear side of combination module 602).

Power cable 702 connects the AC power terminals on the rear side of combination module 602 with main AC power (e.g., via a breaker), providing AC power to outlet 606 and to the AC/DC power converter 614. In addition to powering the A/V signal receiver module 616, DC power from the power converter 614 can also serve as a power-over-HDBaseT (PoH) power source for the HDBaseT link, thus providing DC power to the mating HDMI input module 706. This PoH power can be used to power the indicators 708 on the HDMI input module 706, as well as any other electronics included in the module (e.g., signal amplification and conditioning electronics, heat monitoring and control electronics, etc.). The indicators 610 and 708 on the display and source sides, respectively, can be configured to convey when a connection between the devices is detected, to provide fault indication and to indicate functions such as end-to-end test conditions during initial installation. For example, one of the indicators 610 on combination module 602 may be configured to illuminate when a connection to content source 508 over the HDBaseT link is detected, and one of the indicators 708 on the mating HDMI input module 706 can be configured to illuminate when a connection to the television 106 is detected. In another example, separate indications may be used to indicate when a module detects a connection to another module, and when the module detects a connection to a valid content source or display device. In such example configurations, one of the indicators 610 on combination module 602 may illuminate a first color when the connection to the mating HDMI module is detected over the HDBaseT link, and illuminate a second color when the content source 508 is plugged into the HDMI input module. Communication circuitry in the respective modules (and powered by PoH power on the HDbaseT link sourced by power converter 614) can be configured to perform appropriate handshaking and device detection functions to support these indication functions.

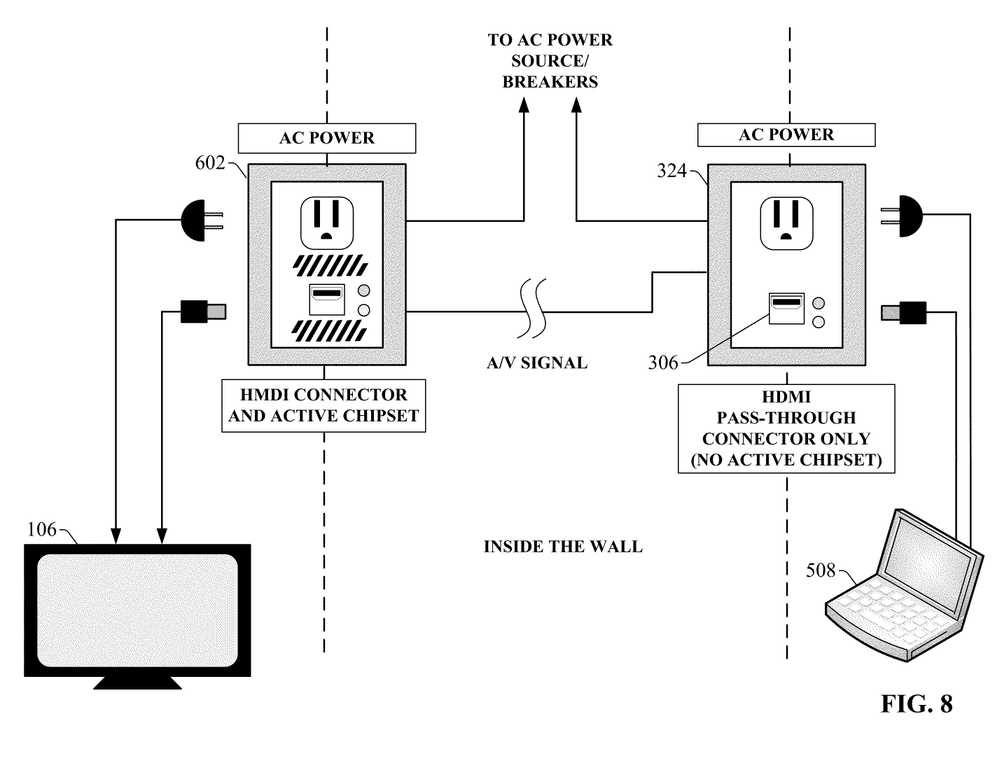

In some configurations, the pass-through type combination module 324 and the active combination module 602 can be used together in one communication link if power to the content source is also required. FIG. 8 is a diagram illustrating a link between content source 508 and television 106 in which a pass-through combination module 324 is installed on the source end. When installed on the source end, the HDMI port 306 on the front of the module serves as an input port that receives the A/V signal from content source 508, passing the signal to the rear connector for transmission to the active combination module 602. Thus, the same module that receives the A/V signal from content source 508 also provides AC power to the source device.

Using the general configurations illustrated in FIGS. 6-8, an AC power receptacle module can be combined with essentially any audio/video connector or with any A/V signal extender, amplifier, and/or converter electronics within a single-gang wall box to provide a simple wall box solution for serving both power and A/V signals to televisions or other displays.

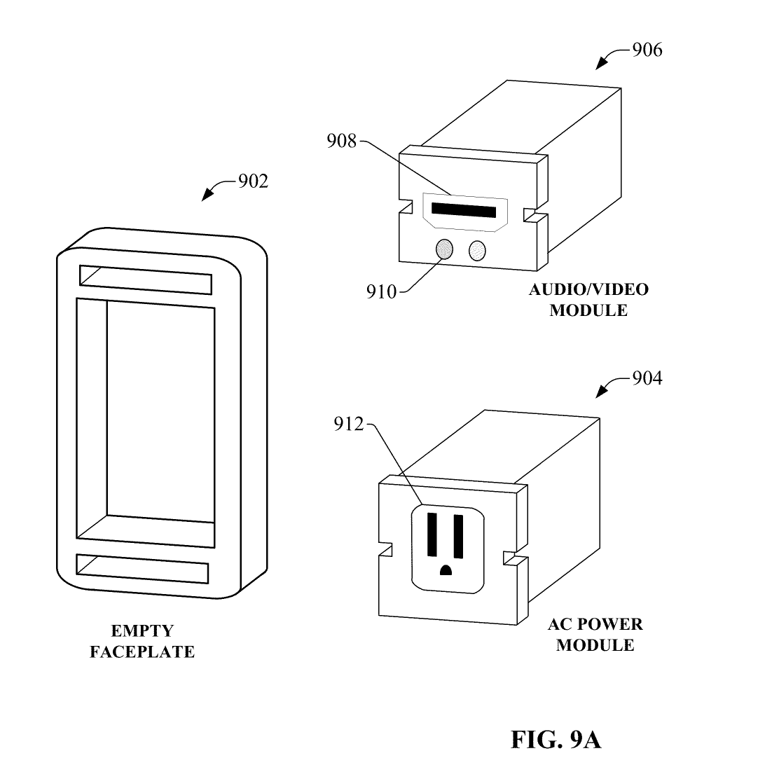

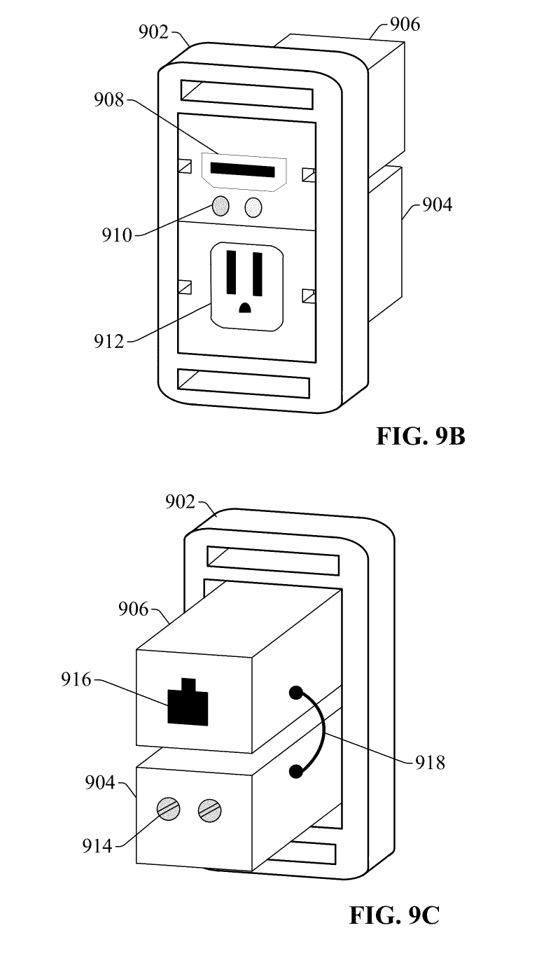

FIGS. 9A-9C are three-dimensional drawings illustrating a modular embodiment of the combination module. This modular embodiment allows an end user to select or modify combinations of AC power and A/V signal outlets as needed. To this end, the AC power receptacle and A/V signal receiver module (or transmission module or transceiver module) are provided as individual removable modules 904 and 906, respectively, which can be inserted into an empty faceplate 902 to yield a composite wall-mountable outlet for both power and A/V signaling. FIG. 9A illustrates the AC power module 904, A/V module 906, and faceplate 902 as separate units, while FIGS. 9B and 9C are front and rear assembled views of the modular components. This modular design also allows the user to select the arrangement of the modules within the faceplate 902 (e.g., whether the AC power module is to reside in the top or bottom position).

Different models of both the A/V module 906 and the AC power module 904 can be made available to allow the user to select the particular combination of AC power and A/V modules best suited for a particular installation. For example, different models of the A/V module 906 can be made available to support a variety of signal port types, including but not limited to HDMI, DisplayPort, USB, DVI, Thunderbolt, coaxial, binding post, banana jack, RJ-45, RJ11, RCA, BNC, etc. Moreover, for some or all display port types, sub-variants of the A/V module can be made available for either active modules—which include signal extender, amplification, conditioning, and/or conversion electronics—or pass-through modules, which only pass the signals (unconditioned) between the receiver port 916 on the rear of the module and the output port 908 on the front of the module. Indicators 910 are provided on the front face of A/V module 906 for models that include active electronics.

AC power module 904 includes an AC power outlet 912 on its front face and AC terminals 914 on its rear face for connection to main AC power. AC power module 904 may be provided either with or without an integrated AC/DC power converter. For example, users may select an AC power module 904 that includes a power converter if the module is to be used with an A/V module that includes active electronics requiring DC power. In some embodiments, DC power can be passed from the AC power module 904 to the A/V module 906 by installing a DC power jumper 918 internally between DC output terminals on the AC power module 904 and DC input terminals on the A/V module 906. In other embodiments, the faceplate 902 and associated modules 906 and 904 may be installed through an open front face of a specialized combination module housing (structurally similar to module housings 310 and 620) which includes a communication bus mounted on the rear inside surface. In such embodiments, the communication bus interfaces with the AC power and A/V modules when the modules are installed in the module housing. The communication bus can facilitate exchange of power and signaling between the AC power and A/V modules within the wall box. In such embodiments, the rear surfaces of AC power module 904 and A/V module 906 can include additional communication module interface ports that electrically connect to the communication bus when the modules are installed in the module housing. In still other embodiments, this communication bus can be a part of the faceplate 902.

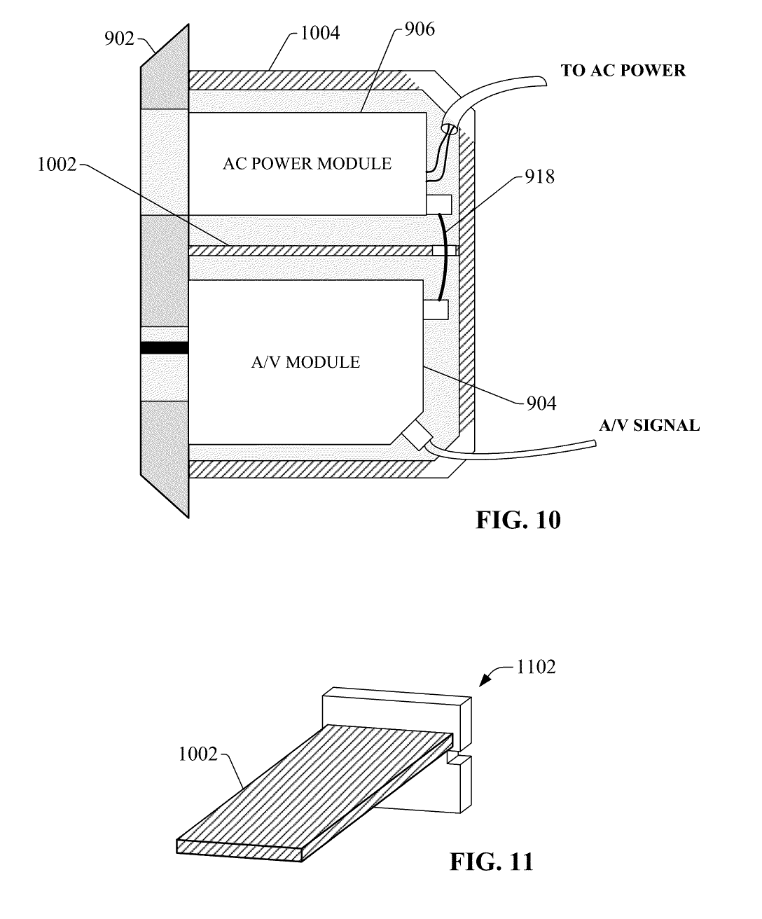

Some electrical codes (e.g., National Electric Code) may not allow both AC power and low voltage A/V signals to reside within the same wall box gang without a barrier between the AC and low voltage compartments. Accordingly, for embodiments in which the modular system depicted in FIGS. 9A-9C does not include a module housing (but instead will be mounted directly the wall box without being enclosed by a module housing), a divider plate can be provided for installation between the AC and signal sides of the gang, as shown in the side view depicted in FIG. 10. In some embodiments, the divider plate 1002 may be an integrated component of the wall box 1004. Alternatively, the divider plate 1002 may be a removable divider module 1102, as illustrated in FIG. 11. The removable divider module 1102 can be inserted into the faceplate 902 between the upper and lower portions of wall box 1004 to provide separation between the two voltage levels. For embodiments in which divider plate 1002 is used, DC power jumper 918 can be routed through a notch or hole in the divider plate, as shown in FIG. 10.

The examples described above are designed to support a variety of in-wall copper cable connections between the source end module and the receiving end module (e.g., category cable provisioned with HDBaseT, standard HDMI cables, etc.). Additionally, some embodiments of the combination modules described herein can leverage fiber optic technology to send the A/V signal from the content source device to the television or display. Since fiber optic cables do not conduct electricity, placing the A/V signals on fiber optic cable within the module effectively isolates the A/V signals from the AC power, allowing the A/V signal lines and AC power lines to reside in the same gang without the need for a divider between the AC power and low-voltage signal sides of the gang or the need to enclose the AC power, AC/DC conversion module, and low-voltage signal modules within a single monolithic block.

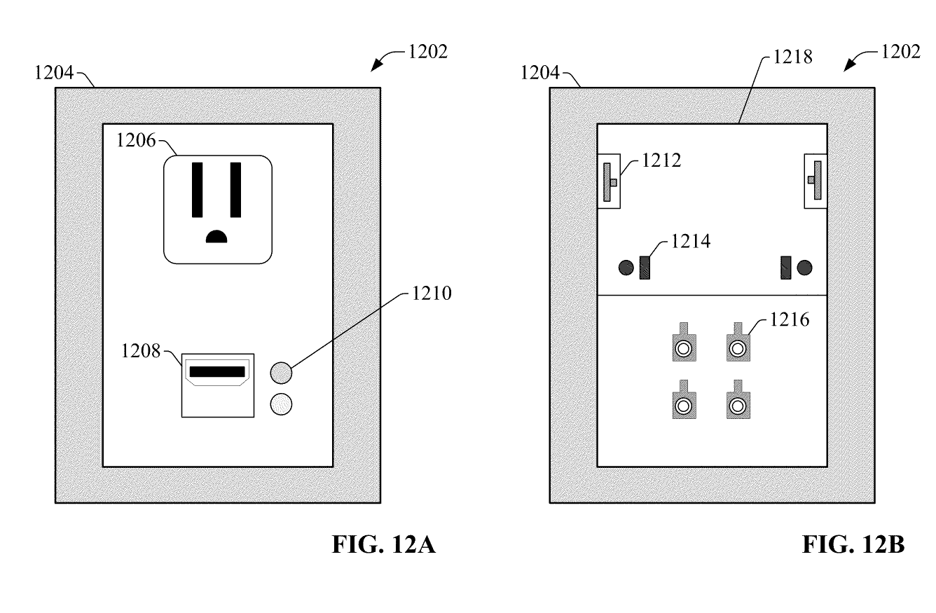

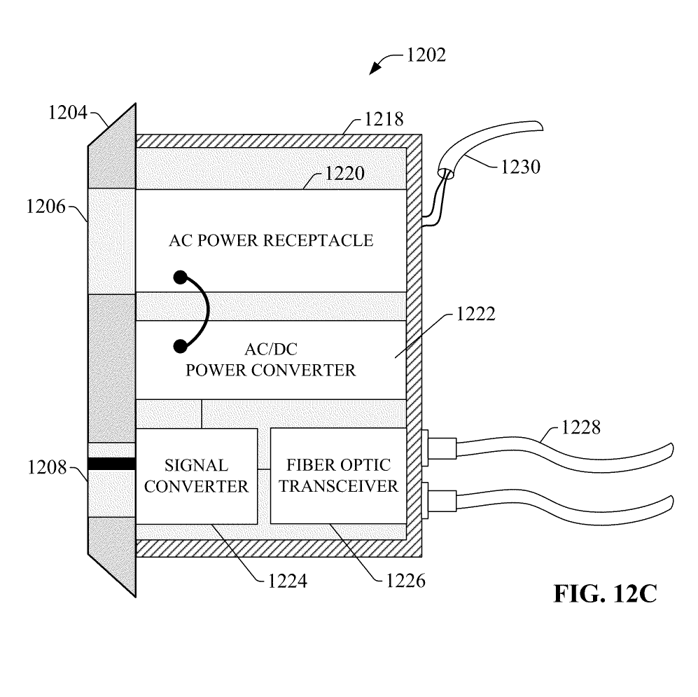

FIGS. 12A-12C are diagrams illustrating front, rear, and side views, respectively, of an example combination module 1202 that includes fiber optic conversion capabilities. Similar to previous examples, combination module 1202 comprises a module housing 1218 and faceplate 1204 that fully enclose the AC power, signal and power conditioning, and communication modules that make up the module. An AC outlet 1206 (part of AC power receptacle 1220) and an A/V port 1208 are exposed through the front face of faceplate 1204. AC power terminals (e.g., screw lug terminals 1212 and/or push-in terminals 1214) are located on the back of combination module 1202. An AC power cable 1230 connected to a main AC circuit (e.g., via a breaker) can be connected to these terminals to provide power to AC power receptacle 1220.

As in previous examples, A/V port 1208 can comprise substantially any type of audio/video port, including but not limited to HDMI, USB, VGA, DVI, DisplayPort, coaxial, etc. A/V port 1208 may also be an audio-only port in some embodiments. The A/V port 1208 is connected to a signal converter 1224 inside the combination module. The combination of signal converter 1224 and fiber optic transceiver 1226 is configured to convert A/V signals into fiber optic signals, and vice versa, thereby allowing fiber optic cables 1228 to be used instead of copper HDMI or category cables for the in-wall cable. Accordingly, fiber optic terminals 1216 may be located on the rear side of the combination module 1202, allowing fiber optic cables 1228 to be terminated on the module inside the wall.

Specifically, optical signals are received via fiber optic cables 1228 and received at fiber optic transceiver 1226 inside the combination module 1202. Fiber optic transceiver 1226 converts the optical signals to electrical signals. Signal converter 1224 receives the electrical signals from fiber optic transceiver 1226 and converts them to A/V signals, which are then output via A/V port 1208. In the reverse direction, signal converter 1224 converts A/V signals from A/V port 1208 to electrical signals, which are then passed to fiber optic transceiver 1226 which converts them to optical signals, for transmission on fiber optic cables 1228. Signal converter 1224 and fiber optic transceiver 1226 can be combined into a single module.

Combination module 1202 includes an AC/DC power converter 1222 to provide DC power to signal converter 1224. Similar to power converter 614, power converter 1222 receives AC power from AC power receptacle 1220 and converts the AC power to an appropriate level of DC power required by the signal converter 1224. Wiring between the AC power receptacle 1220 and power converter 1222, and between power converter 1222 and signal converter 1224, is internal to the combination module 1202.

In some embodiments, A/V port 1208 may be a removable, front-loaded module similar to A/V module 906 described above. This allows the user to swap A/V port types in and out of module housing 1218 as needed depending on the type of A/V connection required by the television or content source. In these embodiments, the A/V module electrically connects to the power converter 1222 and the signal converter 1224 when inserted through the front face of faceplate 1204, mitigating the need to rewire the A/V module to the other internal components. In some embodiments, the removable A/V module may include both the A/V port 1208 and the signal converter 1224, the latter of which electrically connects to the fiber optic transceiver 1226 when the A/V module is inserted through faceplate 1204.

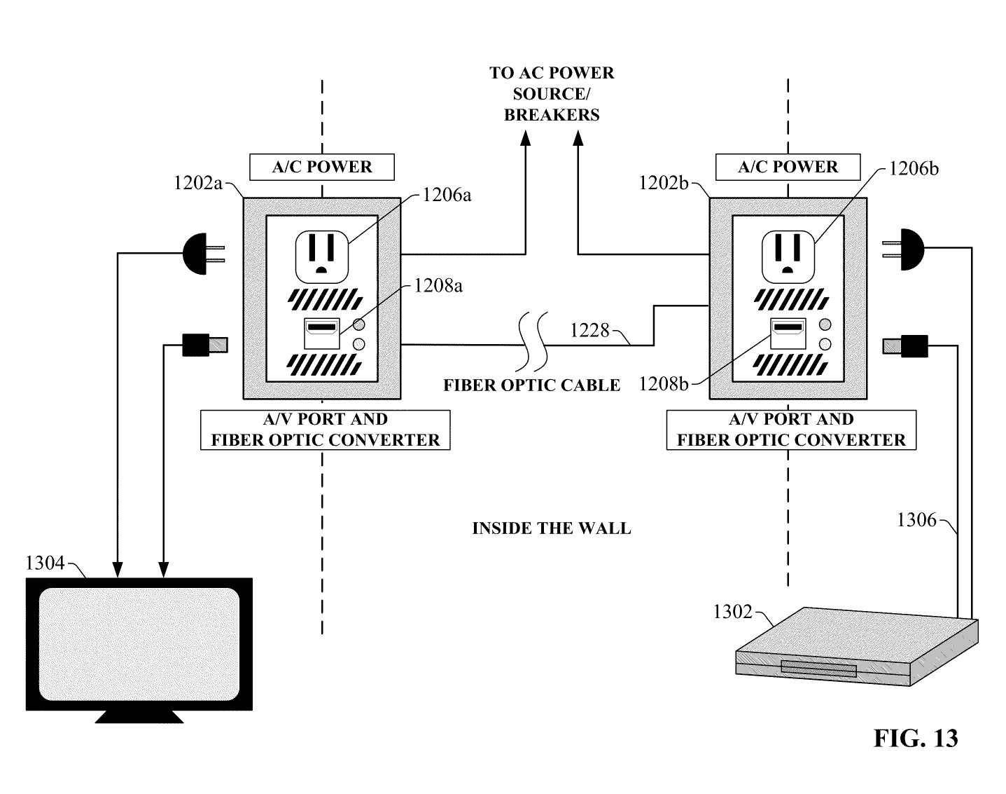

FIG. 13 is a diagram illustrating an example configuration that uses the fiber optic combination module 1202 on both the source end and the display end. On the source end, a content source 1302 receives AC power through outlet 1206b, and A/V cable 1306 plugs into A/V port 1208b. A/V signals generated by content source 1302 are input into A/V port 1208b and converted to fiber optic signals by the combination of signal converter 1224 and fiber optic transceiver 1226, after which the converted signals are sent to combination module 1202a on the display side via fiber optic cable 1228 inside the wall. The fiber optic signals are received and converted back to A/V signals by combination module 1202a, and the converted A/V signals are output via A/V port 1208a for display on television 1304, which also receives AC power from AC outlet 1206a.

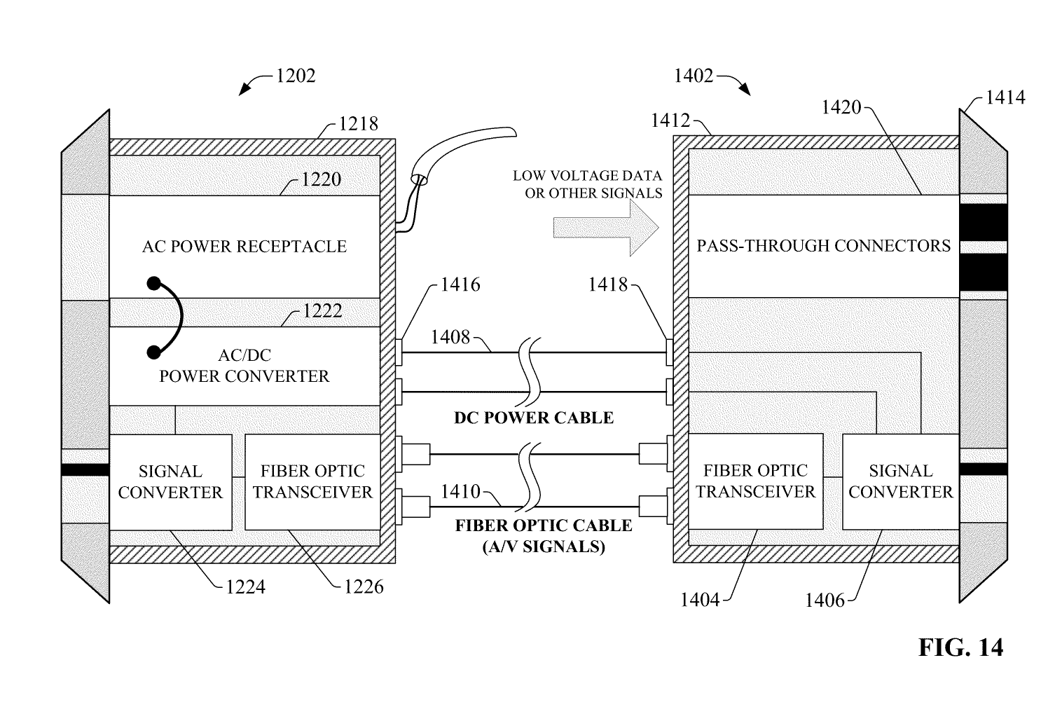

Some embodiments of the fiber optic combination module may also be provided without AC power capabilities. In such embodiments, the AC power portion of the module may be replaced with pass-through data ports that can be used for additional signaling, with power being provided from a mating combination module at another location. FIG. 14 is a diagram illustrating connections between a fiber optic combination module 1202 with AC power capabilities and a combination module 1402 without native AC power. Similar to combination module 1202, combination module 1402 includes a signal converter 1406 and a fiber optic transceiver 1404. However, combination module 1402 does not include an AC power receptacle; instead, the upper portion of the module housing 1412 houses one or more pass-through connectors 1420 for additional data signal lines (e.g., RJ-45, HDMI, USB, etc.). In some embodiments, the pass-through connectors 1420 may have a swappable modular form factor allowing the user to select the types of data ports available on the upper portion of faceplate 1414.

Since combination module 1402 does not include an AC receptacle or power converter, signal converter 1406 receives DC power from power converter 1222 of the mating combination module 1202. To this end, a low voltage DC power cable 1408 connected to DC output terminals 1416 on the rear side of combination module 1202 can be routed through the wall and connected to DC input terminals 1418 on the rear side of combination module 1402. Internal wiring routes this DC power to signal converter 1406. DC power cable 1408 can also be combined in a single cable sheath with fiber optic cable 1410.

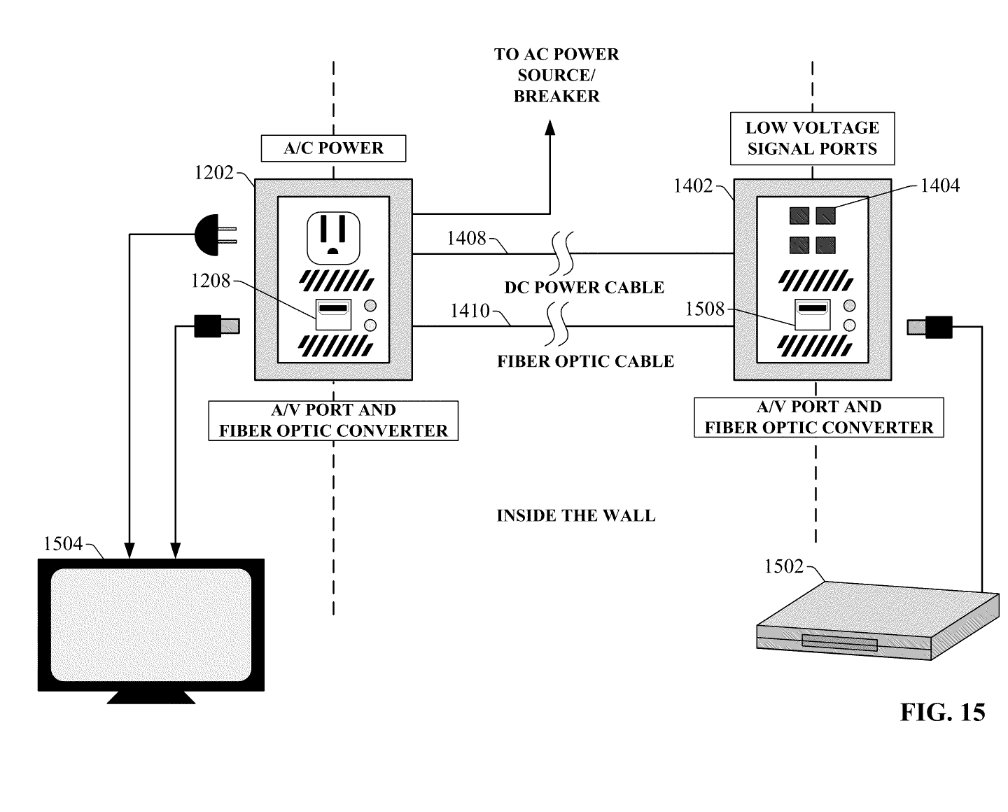

Using this arrangement, AC power is only needed at one end of the A/V link (though a DC cable 1408 must be run between the two combination modules in addition to the fiber optic cable 1410). FIG. 15 is a diagram illustrating a link between a content source 1502 and a television 1504 using this arrangement. As shown in this figure, only combination module 1202 on the display end of the link requires a connection to main AC power, since the power converter 1222 of combination module 1202 provides DC power to combination module 1402 on the source end via DC power cable 1408. Fiber optic cable 1410 within the wall links the two combination modules, allowing audio/video signals to be sent from the A/V input port 1508 of combination module 1402 to A/V port 1208 of combination module 1202. Since fiber optic transceivers 1226 and 1404 are bi-directional, combination modules 1202 and 1402 can also be reversed on the A/V link if desired; that is, the AC power combination module 1202 can be provisioned on the source end of the link, with combination module 1402 placed on the display end of the link.

Pass-through connectors 1420 on the front face of combination module 1402 can provide data ports for additional data lines within the wall (e.g., Ethernet ports, USB ports, etc.). Moreover, some embodiments of combination module 1402 may include additional electronics that deliver a portion of the DC power received on the DC power cable 1408 to one or more of the connectors 1420, turning those connectors into charging ports for charging portable devices (e.g., USB charging ports).

This configuration depicted in FIGS. 14 and 15, whereby DC power from one module is provided to another module without native AC or DC power, can also be extended to the other combination module embodiments described herein.

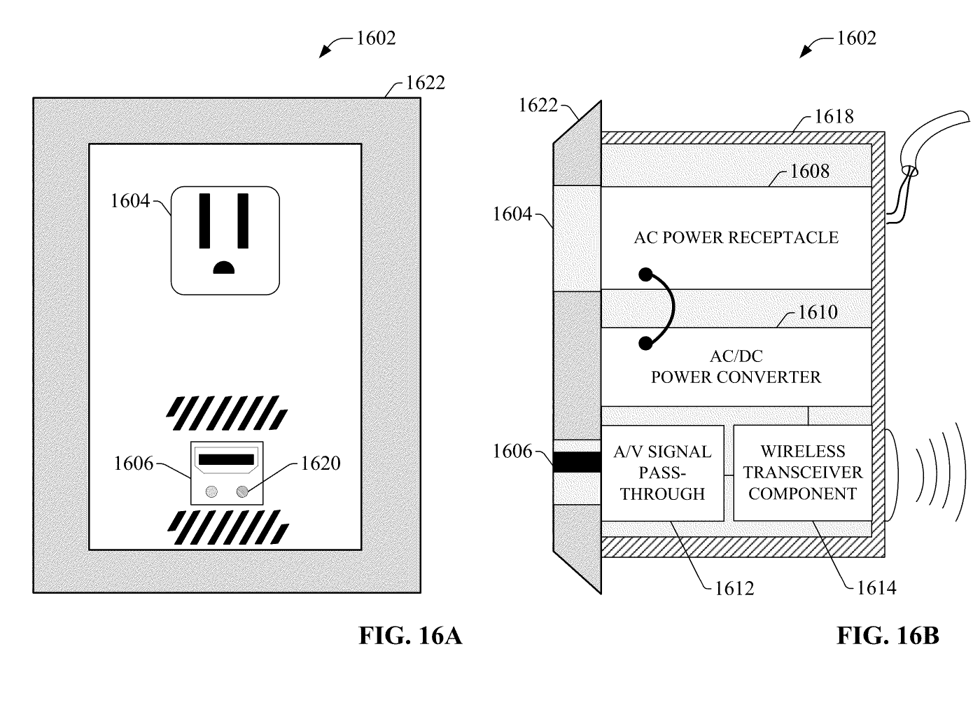

FIGS. 16A and 16B are diagrams illustrating front and side views, respectively, of a combination module 1602 that leverages wireless technology to connect the source and display ends of an A/V link. Similar to previous examples, combination module 1602 comprises an AC power receptacle housed in the upper portion of module housing 1618, which provides power to AC power outlet 1604. An A/V port 1606 (e.g., an HDMI port, a USB port, an RJ-45 port, a VGA port, or another type of A/V signal port) residing on the lower portion of module housing 1618 is configured to send and/or receive A/V signals from a display or content source. In this embodiment, combination module 1602 establishes an A/V link with another module via a wireless link rather than a copper cable or fiber optic cable. This eliminates the need to run a cable through the wall for exchange of A/V signals between the content source and the display device. To this end, combination module 1602 includes a wireless transceiver component 1614 configured to receive an A/V signal from A/V port 1606 (e.g., via A/V signal pass-through 1612), and convert the signal to a wireless protocol for transmission to a mating combination module on the opposite end of the A/V link. Wireless transceiver component 1614 is also configured to receive wireless A/V signals from the mating combination module and convert the received wireless signals to the appropriate A/V signal protocol, and to output the resulting A/V signal via A/V port 1606.

The AC power receptacle 1608, AC/DC power converter 1610, A/V signal pass-through 1612, and wireless transceiver component 1614 are fully enclosed within the module housing 1618 and faceplate 1622 (except for the outlets, ports, and terminals that face outward through the faceplate 1604 and the rear surface of the housing). As in previous examples, indicators 1620 on the front face of the combination module 1602 can indicate A/V communication status and health information. In one or more wireless embodiments, indicators 1620 may include separate indicators for wireless communication statuses (e.g., wireless link OK, mating combination module found, etc.) and A/V communication statuses (A/V data received/sent, etc., source device ready, display device ready, etc.). In some embodiments, the combination module 1602 may also include audible feedback for certain status indications.

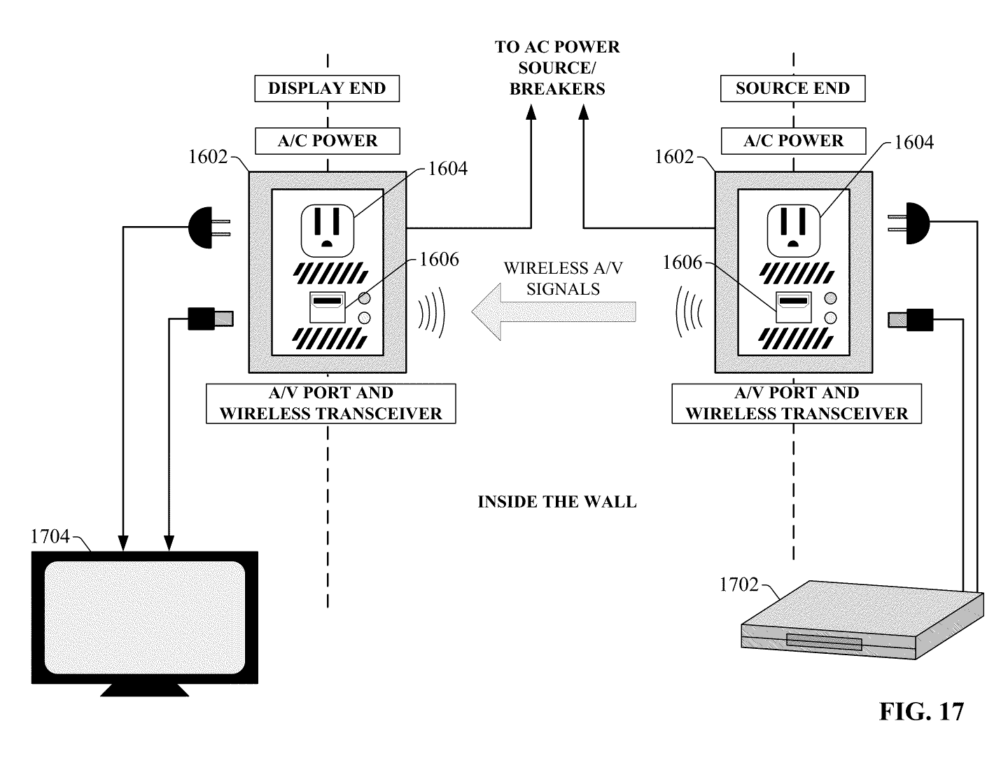

FIG. 17 is a diagram illustrating an example configuration that uses combination module 1602 with wireless transceiver component 1614 on both the source end and the display end. In this example configuration, the wireless transceiver component 1614 of the combination module 1602 on the source end transmits A/V signals from source device 1702 on a wireless signal. The wireless signal is received by the wireless transceiver component 1614 of the combination module 1602 on the display end. The display end wireless transceiver component 1614 then extracts the original A/V signal from this received wireless signal and outputs the recovered A/V signal via the A/V port 1606 for delivery to display device 1704.

In one or more embodiments, the AC power receptacle 1608 and the A/V port 1606 (and associated electronics) may conform to a modular form factor similar to that depicted in FIGS. 9A-9C. In such embodiments, the removable A/V module may include both the A/V signal pass-through 1612 and the wireless transceiver component 1614, allowing the user to replace an A/V module that supports a copper wall connection (e.g., A/V module 906 of FIGS. 9A-9C) with a wireless version without replacing the entire module housing 1618 or faceplate 1622. Alternatively, the wireless transceiver component 1614 may be fixed within module housing 1618, such that interface electronics within the removable A/V module connect to the wireless transceiver component 1614 when the A/V module is inserted through faceplate 1622. In this latter scenario, the user may select the A/V module corresponding to the type of A/V port required for a given installation, and the wireless transceiver component 1614 will suitably convert between the A/V signal type corresponding to the selected A/V port and the wireless protocol.

In general, removable A/V modules corresponding to the form factors depicted in FIGS. 9A-9C can be provided for substantially any combination of front-facing A/V port type and rear-facing (in-wall) connector type. That is, for each type of A/V port (e.g., HDMI, USB, DisplayPort, etc.), a removable A/V module can be provided for each type of in-wall connection (e.g., RJ-45, HDMI, fiber optic, wireless, etc.). These flexible modular designs allow a user to customize one or more embodiments of the combination module to suit the source and display device types and the desired in-wall connection type.

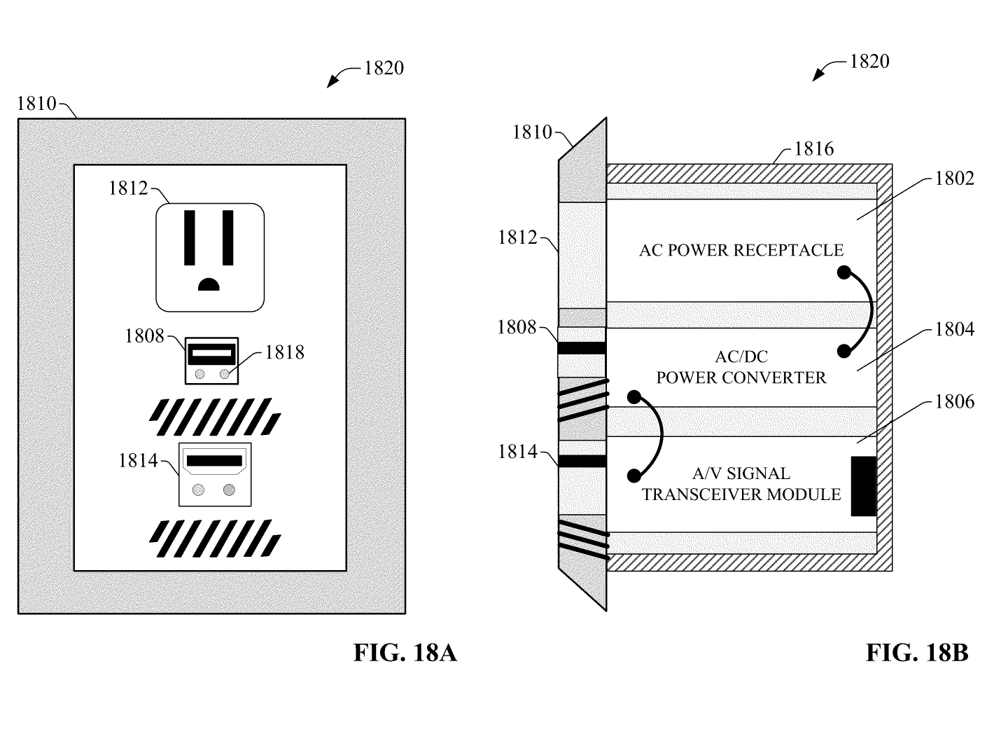

FIGS. 18A and 18B are front and side views, respectively, of an embodiment in which an AC outlet 1812, a USB charging port 1808, and an A/V port 1814 are combined in a combination module 1820 that can be fitted inside a single-gang wall box. In this example, A/V signal transceiver module 1806 functions as described in previous examples. Internal electrical connections within the module housing 1816 connect the power receptacle 1802 to the AC/DC power converter 1804, and the power converter 1804 to the A/V signal transceiver module 1806. In this embodiment, DC power from power converter 1804 provides DC power to the A/V signal transceiver module 1806 (to power the signal extender circuitry) as well as DC charging power to USB charging port 1808. To this end, power converter 1804 can include power conditioning components that transform the AC power to an appropriate USB power standard and provide the converted DC power to USB charging port 1808, which can then deliver the converted USB power to a USB-capable electronic device (e.g., phone, tablet computer, laptop, etc.) plugged into the USB port. USB charging port 1808 can conform to any USB jack type, including but not limited to standard USB, mini USB, micro USB, USB 2.0, USB 3.0, or other standard.

In some embodiments, combination module 1820 can include charging status indicators 1818 that convey status information relating to operation of USB charging port 1808 including, but not limited to, an indication that charging power is present at the USB charging port 1808, a charging status of a connected USB device (e.g., “connected and charging,” “charging complete,” “no device detected,” etc.), or other such status information. The status indicators 1818 can comprise any suitable visual or audible output components; e.g., light emitting diodes (LEDs), audible signal generators, electronic text display etc.

Although examples of combination modules have been described herein as combining AC power receptacles and A/V signal ports within an integrated housing, some embodiments may include other types of data ports in place of the A/V signal port without departing from the scope of this disclosure.

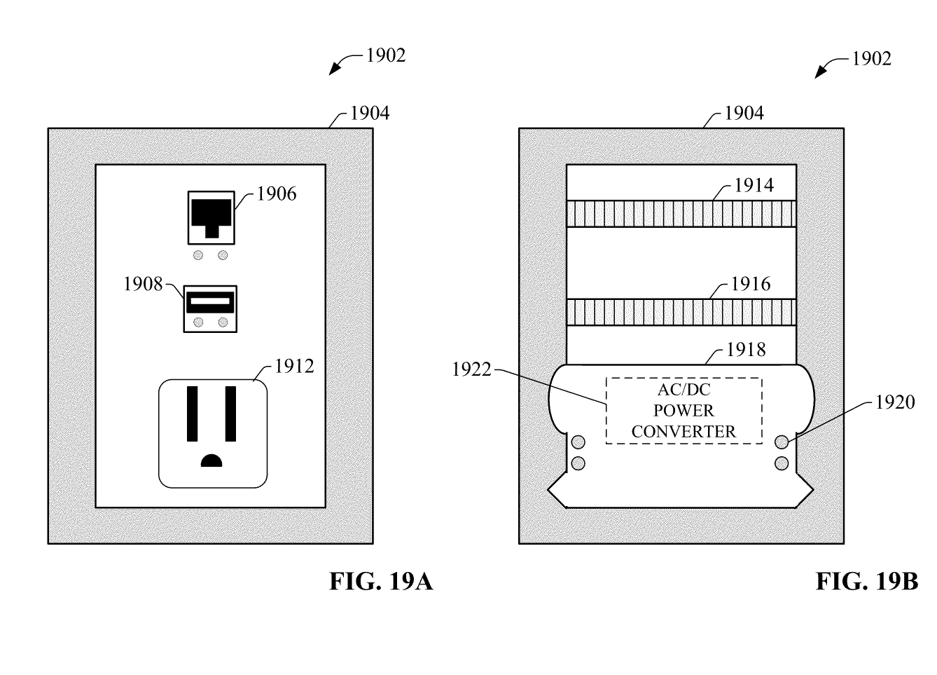

FIGS. 19A and 19B are diagrams illustrating front and rear views, respectively, of an example combination module 1902 that combines an AC power outlet 1912, an Ethernet port 1906 (e.g., RJ-45), and a USB charging port 1908 within one single-gang wall box. In this example, a surge receptacle 1918 with AC input terminals 1920 (e.g., screw terminals and/or push-in terminals) provides AC power to AC outlet 1912. The combination module 1902 also comprises an AC/DC power converter 1922 that converts a portion of the AC power available in surge receptacle 1918 to DC power and provides the DC power to Ethernet port 1906 and USB charging port 1908 as charging power. Thus, the USB charging port 1908 can be used to charge USB-compatible mobile devices (e.g., phones, tablet computers, laptop computers, etc.), while Ethernet port 1906 is capable of providing PoE power. Power converter 1922 can be configured to output DC power at different levels to suit the charging power requirements of the USB charging port 1908 and Ethernet port 1906, respectively.

Moreover, combination module 1902 can serve as a power-over-Ethernet injector by routing the converted PoE power to punch-down terminals 1916 (e.g., 110 insulation displacement contact punch-down terminals) on the rear side of combination module 1902. Conductors of an Ethernet cable that are broken out and terminated on punch-down terminals 1916 are thereby provisioned with PoE power. Punch-down terminals 1914, located above the outgoing PoE punch-down terminals 1916, can serve as data terminals for Ethernet port 1906, allowing data to be exchanged between an Ethernet cable terminated on the punch-down terminals 1914 and Ethernet port 1906.

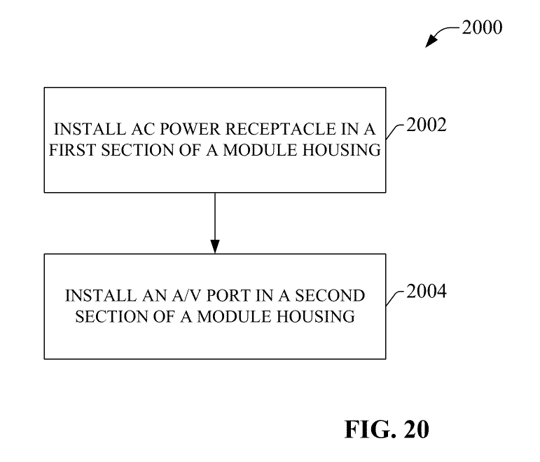

FIGS. 20-22 illustrate various methodologies in accordance with one or more embodiments of the subject application. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 20 illustrates an example methodology 2000 for provisioning both AC power and A/V signaling within a single integrated module. At 2002, an AC power receptacle is installed in a first section of a module housing (e.g., in the top or bottom section of the module housing). The module housing can be sized to fit within a single-gang wall box for wall-mounted installations. At 2004, an A/V port is installed in a second section of the module housing. The A/V port can comprise any suitable type of audio-video port, including but not limited to HDMI, VGA, USB, DVI, DisplayPort, coaxial, binding post, banana jack, RJ-45, RJ11, RCA, BNC, Thunderbolt, or other types of A/V signal ports. The module housing fully encloses the AC power receptacle and the A/V power together within a single module.

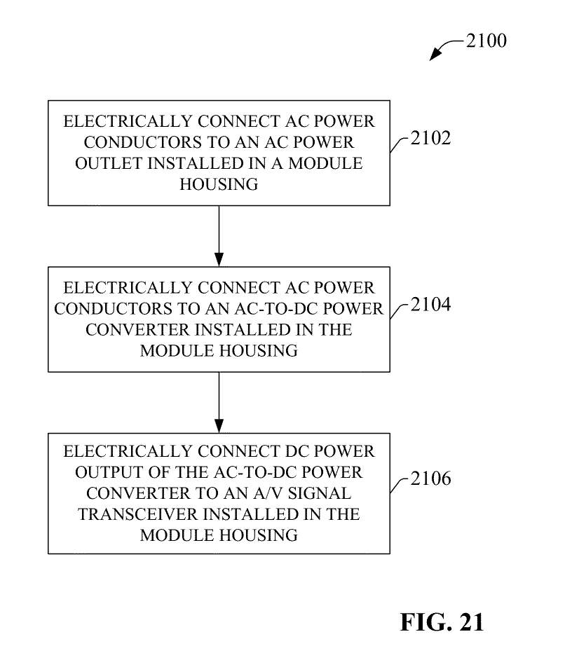

FIG. 21 illustrates an example methodology 2100 for configuring an outlet box with both AC power and an A/V port with active signal extension electronics. Initially, at 2102, AC power conductors are electrically connected to an AC power outlet mounted in a module housing (e.g., in a top or bottom section of the module housing). At 2104, the AC power conductors are electrically connected to an AC-to-DC power converter installed in the module housing. At 2106, the DC power output of the AC-to-DC power converter is electrically connected to an A/V signal transceiver installed in the module housing. The A/V signal transceiver can be configured to pass A/V signals between an A/V port installed in the module housing and facing outward through a faceplate of the housing and a rear-side A/V port for sending and/or receiving A/V signals inside the wall. The A/V signal transceiver can also include electronics—powered by the DC power output—for amplifying, conditioning, correcting, and/or converting the A/V signals.

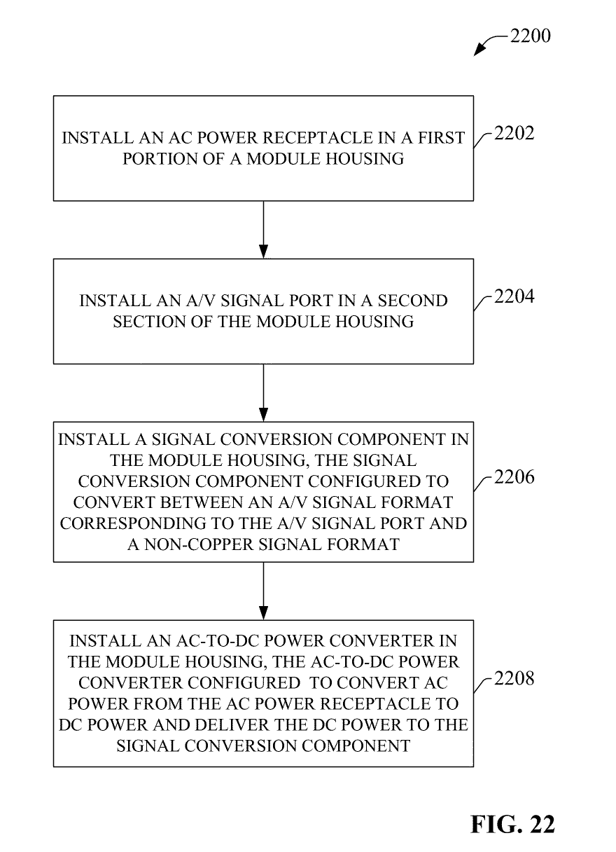

FIG. 22 illustrates an example methodology 2200 for sharing AC power and A/V signaling within a single-gang outlet box while mitigating risk of cross-over between AC and signaling lines. Initially, at 2202, an AC power receptacle is installed in a first portion of a module housing (e.g., the top portion or the bottom portion). At 2204, an A/V signal port is installed in a second section of the module housing. At 2206, a signal conversion component is installed in the module housing, where the signal conversion component is configured to convert between an A/V signal format corresponding to the A/V signal port and a non-copper signal format. The A/V signal format may comprise, for example, a format compatible with HDMI, USB, DisplayPort, etc. The non-copper signal format may comprise fiber optic, wireless, or another non-copper format. At 2208, an AC-to-DC converter is installed in the module housing. The AC-to-DC converter can be configured to covert AC power from the AC power receptacle to DC power and deliver the DC power to the signal conversion component. The module housing fully encloses the AC power receptacle, A/V signal port, signal conversion component, and AC-to-DC power converter (excepting the ports, outlets, and/or terminals exposed through the module housing or associated faceplate).

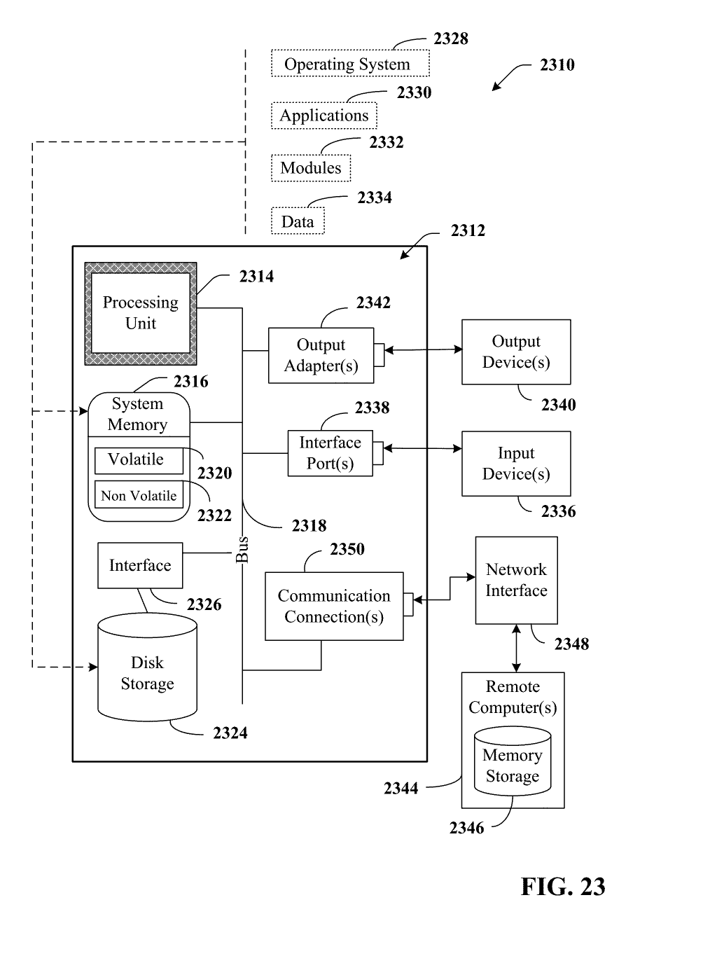

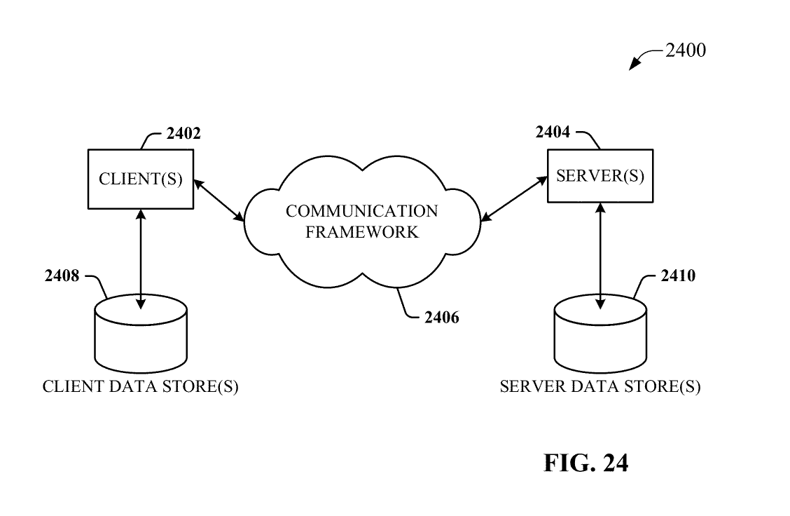

In order to provide a context for the various aspects of the disclosed subject matter, FIGS. 23 and 24 as well as the following discussion are intended to provide a brief, general description of a suitable environment in which the various aspects of the disclosed subject matter may be implemented.

With reference to FIG. 23, an example environment 2310 for implementing various aspects of the aforementioned subject matter includes a computer 2312. The computer 2312 includes a processing unit 2314, a system memory 2316, and a system bus 2318. The system bus 2318 couples system components including, but not limited to, the system memory 2316 to the processing unit 2314. The processing unit 2314 can be any of various available processors. Multi-core microprocessors and other multiprocessor architectures also can be employed as the processing unit 2314.

The system bus 2318 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 2316 includes volatile memory 2320 and nonvolatile memory 2322. The basic input/output system (BIOS), containing the basic routines to transfer information between elements within the computer 2312, such as during start-up, is stored in nonvolatile memory 2322. By way of illustration, and not limitation, nonvolatile memory 2322 can include read only memory (ROM), programmable ROM (PROM), electrically programmable ROM (EPROM), electrically erasable PROM (EEPROM), or flash memory. Volatile memory 2320 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 2312 also includes removable/non-removable, volatile/non-volatile computer storage media. FIG. 12 illustrates, for example a disk storage 2324. Disk storage 2324 includes, but is not limited to, devices like a magnetic disk drive, floppy disk drive, tape drive, Jaz drive, Zip drive, LS-100 drive, flash memory card, or memory stick. In addition, disk storage 2324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 2324 to the system bus 2318, a removable or non-removable interface is typically used such as interface 2326.

It is to be appreciated that FIG. 23 describes software that acts as an intermediary between users and the basic computer resources described in suitable operating environment 2310. Such software includes an operating system 2328. Operating system 2328, which can be stored on disk storage 2324, acts to control and allocate resources of the computer 2312. System applications 2330 take advantage of the management of resources by operating system 2328 through program modules 2232 and program data 2334 stored either in system memory 2316 or on disk storage 2324. It is to be appreciated that one or more embodiments of the subject disclosure can be implemented with various operating systems or combinations of operating systems.

A user enters commands or information into the computer 2312 through input device(s) 2336. Input devices 2336 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 2314 through the system bus 2318 via interface port(s) 2338. Interface port(s) 2338 include, for example, a serial port, a parallel port, a game port, and a universal serial bus (USB). Output device(s) 2340 use some of the same type of ports as input device(s) 2336. Thus, for example, a USB port may be used to provide input to computer 2312, and to output information from computer 2312 to an output device 2340. Output adapters 2342 are provided to illustrate that there are some output devices 2340 like monitors, speakers, and printers, among other output devices 2340, which require special adapters. The output adapters 2342 include, by way of illustration and not limitation, video and sound cards that provide a means of connection between the output device 2340 and the system bus 2318. It should be noted that other devices and/or systems of devices provide both input and output capabilities such as remote computer(s) 2344.

Computer 2312 can operate in a networked environment using logical connections to one or more remote computers, such as remote computer(s) 2344. The remote computer(s) 2344 can be a personal computer, a server, a router, a network PC, a workstation, a microprocessor based appliance, a peer device or other common network node and the like, and typically includes many or all of the elements described relative to computer 2312. For purposes of brevity, only a memory storage device 2346 is illustrated with remote computer(s) 2344. Remote computer(s) 2344 is logically connected to computer 2312 through a network interface 2348 and then physically connected via communication connection 2350. Network interface 2348 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 2350 refers to the hardware/software employed to connect the network interface 2348 to the system bus 2318. While communication connection 2350 is shown for illustrative clarity inside computer 2312, it can also be external to computer 2312. The hardware/software necessary for connection to the network interface 2348 includes, for exemplary purposes only, internal and external technologies such as, modems including regular telephone grade modems, cable modems and DSL modems, ISDN adapters, and Ethernet cards.

FIG. 24 is a schematic block diagram of a sample computing environment 2400 with which the disclosed subject matter can interact. The sample computing environment 2400 includes one or more client(s) 2402. The client(s) 2402 can be hardware and/or software (e.g., threads, processes, computing devices). The sample computing environment 2400 also includes one or more server(s) 2404. The server(s) 2404 can also be hardware and/or software (e.g., threads, processes, computing devices). The servers 2404 can house threads to perform transformations by employing one or more embodiments as described herein, for example. One possible communication between a client 2402 and servers 2404 can be in the form of a data packet adapted to be transmitted between two or more computer processes. The sample computing environment 2400 includes a communication framework 2406 that can be employed to facilitate communications between the client(s) 2402 and the server(s) 2404. The client(s) 2402 are operably connected to one or more client data store(s) 2408 that can be employed to store information local to the client(s) 2402. Similarly, the server(s) 2404 are operably connected to one or more server data store(s) 2410 that can be employed to store information local to the servers 2404.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

1. An apparatus, comprising:
a module housing;
an alternating current (AC) power receptacle located in a first portion of the module housing and comprising an electrical outlet that faces outward through a front surface of the module housing; and
a data port module located in a second portion of the module housing and removable via the front surface of the module housing, wherein the data port module comprises a front data port that faces outward through the front surface of the module housing and is configured to exchange A/V signaling with a rear data port located on a rear surface of the data port module.

2. The apparatus of claim 1, wherein the module housing is configured to be installed within a single-gang wall box.

3. (canceled)

4. The apparatus of claim 1, wherein at least one of the front data port or the rear data port comprises at least one of a high-definition multimedia interface (HDMI) port, a video graphics array (VGA) port, a universal serial bus (USB) port, a digital video interface (DVI) port, a display port, a coaxial port, a binding post port, a banana jack port, a registered jack 45 (RJ-45) port, an RJ-11 port, a Radio Corporation of America (RCA) port, a Bahyonet Neill-Concelman (BNC) port, a fiber optic port, or a Thunderbolt port.

5. The apparatus of claim 4, wherein the rear data port comprises a different type of port than the front data port, and the data port module further comprises a signal conversion component configured to convert between a first signal type corresponding to the front data port and a second signal type corresponding to the rear data port.

6. The apparatus of claim 1, further comprising a power conversion component located within the module housing, wherein the power conversion component is configured to transform AC power from the AC power receptacle to direct current (DC) power.

7. The apparatus of claim 6, wherein
the rear data port comprises a fiber optic data port,
the data port module further comprises a signal conversion component configured to convert between a signal type corresponding to the front data port and a fiber optic signal type, and
the power conversion component is configured to provide the DC power to the signal conversion component.

8. The apparatus of claim 6, wherein the rear data port comprises a wireless transceiver component configured to at least one of
transmit, on a first wireless signal, a first A/V signal received by the front data port, or
transform a second wireless signal received at the rear data port to a second A/V signal and output the second A/V signal via the front data port, and
wherein the power conversion component is configured to provide the DC power to the wireless transceiver component.

9. The apparatus of claim 6, wherein the data port module further comprises a signal extending component configured to at least one of amplify, condition, correct, or convert the A/V signaling, and wherein the power conversion component is configured to provide the DC power to the signal extending component.

10. (canceled)

11. The apparatus of claim 6, further comprising a universal serial bus (USB) port that faces outward through the front surface of the module housing, wherein the power conversion component is configured to provide the DC power to the USB port.

12. The apparatus of claim 1, further comprising at least one indicator configured to indicate communication status information relating to the data port module.

13. A modular outlet device, comprising:
a faceplate configured to mount to a front of a module housing;
an alternating current (AC) power receptacle module comprising an AC outlet on a surface and configured to be inserted through the faceplate; and
a data port module configured to be inserted through the faceplate, wherein the data port module comprises a front data port on a front face of the data port module and a rear data port on a rear face of the data port module, and is configured to pass audio/video (A/V) signaling between the front data port and the rear data port.

14. The modular outlet device of claim 13, further comprising a divider module configured to be inserted through the faceplate, wherein the divider module comprises a divider plate that positions between the AC power receptacle module and the data port module while the divider module is inserted through the faceplate.

15. The modular outlet device of claim 13, wherein the AC power receptacle comprises a power conversion module configured to convert AC power from the AC outlet to direct current (DC) power and output the DC power via DC output terminals.

16. The modular outlet device of claim 15, wherein the data port module comprises:
a signal conversion component configured to convert between a first signal type corresponding to the front data port and a second signal type corresponding to the rear data port; and
DC input terminals configured to electrically connect to the DC output terminals, wherein the DC input terminals provide the DC power to the signal conversion component.

17. The modular outlet device of claim 15, wherein the data port module comprises:
a wireless transceiver configured to at least one of
transmit, on a first wireless signal, a first A/V signal from the front data port, or
transform a second wireless signal received at the wireless transceiver to a second A/V signal and output the second A/V signal via the front data port; and
DC input terminals configured to electrically connect to the DC output terminals, wherein the DC input terminals provide the DC power to the wireless transceiver component.

18. The modular outlet device of claim 15, wherein the data port module comprises:
a signal extending component configured to at least one of amplify, condition, correct, or convert A/V signaling received via the front data port or the rear data port; and
DC input terminals configured to electrically connect to the DC output terminals, wherein the DC input terminals provide the DC power to the signal extending component.

19. A system, comprising:
means for outputting alternating current (AC) power via an AC outlet; and
means for exchanging audio/video (A/V) signaling between a first data port on a front surface of the means for exchanging and a second data port on a rear surface of the means for exchanging,
wherein the means for exchanging the A/V signaling resides in a module housing and is removable via a front surface of the module housing.

20. The system of claim 19, further comprising means for converting AC power from the means for outputting to direct current (DC) power and providing the DC power to the means for exchanging, wherein the means for converting resides in the module housing.

21. The apparatus of claim 7, wherein the module housing further comprises DC terminals on a rear surface of the module housing, the DC terminals configured to output the DC power.

22. The apparatus of claim 8, wherein the wireless transceiver component is configured to transmit the first wireless signal to another wireless transceiver component installed in another module housing and to receive the second wireless signal from the other wireless transceiver component.
